(19) United States
(12) Patent Application Publication
(10) Pub. No.: US 2024/0103425 A1
(43) Pub. Date: Mar. 28, 2024

(54) COLLECTING DEVICE AND IMAGE FORMING APPARATUS

(71) Applicant: FUJIFILM Business Innovation Corp., Tokyo (JP)

(72) Inventors: Shinya MAKIURA, Kanagawa (JP); Yuji Kikuchi, Kanagawa (JP); Yu Tsuda, Kanagawa (JP); Yusuke Kitagawa, Kanagawa (JP); Shun Ida, Kanagawa (JP); Takaki Saiki, Kanagawa (JP)

(73) Assignee: FUJIFILM Business Innovation Corp., Tokyo (JP)

(21) Appl. No.: 18/179,611

(22) Filed: Mar. 7, 2023

(30) Foreign Application Priority Data
Sep. 27, 2022 (JP) 2022-153546

(51) Int. Cl. G03G 21/10; G03G 15/00

(52) U.S. Cl. CPC G03G 21/105; G03G 15/5016

(57) ABSTRACT

A collecting device includes a collecting path for a developer, at least one transport member that is disposed in the collecting path and that transports the developer by rotating, a driving unit that drives, by receiving electric power, the transport member in such a manner that the transport member rotates, a detecting unit that detects a load applied to the driving unit due to transportation of the developer, and a control unit that controls the driving unit based on the load detected by the detecting unit.

### CROSS-REFERENCE TO RELATED APPLICATIONS

This application is based on and claims priority under 35 USC 119 from Japanese Patent Application No. 2022-153546 filed Sep. 27, 2022.

### BACKGROUND

### (i) Technical Field

The present disclosure relates to a collecting device and an image forming apparatus.

### (ii) Related Art

Japanese Unexamined Patent Application Publication No. 2007-328040 discloses a powder collecting device including a powder collecting container into which powder is collected and accumulated, a powder inlet formed in the powder collecting container, a powder transport unit that transports the powder within the powder collecting container, and a powder-transport driving source that transmits a driving force to the powder transport unit. The powder collecting device further includes a powder-transport driving control unit that switches between a continuous driving mode in which the powder-transport driving source is continuously driven and an intermittent driving mode in which the powder-transport driving source is repeatedly driven and stopped.

Japanese Unexamined Patent Application Publication No. 2014-016455 discloses a toner-state predicting device including a changing unit that changes the rotational speed of a stepping motor, which drives a toner collecting mechanism in an image forming apparatus, a detecting unit that detects a loss of synchronism of the stepping motor, and a predicting unit that makes a prediction about clogging of the toner collecting mechanism with a toner on the basis of the rotational speed changed by the changing unit and on the basis of whether the detecting unit has detected a loss of synchronism.

### SUMMARY

Aspects of non-limiting embodiments of the present disclosure relate to suppression of clogging of a collecting path with a developer in a configuration in which the developer is collected compared with a configuration in which a developer transport operation is changed in accordance with an elapsed time.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a collecting device including a collecting path for a developer, at least one transport member that is disposed in the collecting path and that transports the developer by rotating, a driving unit that drives, by receiving electric power, the transport member in such a manner that the transport member rotates, a detecting unit that detects a load applied to the driving unit due to transportation of the developer, and a control unit that controls the driving unit based on the load detected by the detecting unit.

### BRIEF DESCRIPTION OF THE DRAWINGS

An exemplary embodiment of the present disclosure will be described in detail based on the following figures, wherein:

FIG. 1 is a schematic diagram illustrating an image forming apparatus according to the present exemplary embodiment;

FIG. 2 is a perspective view illustrating a collecting device according to the present exemplary embodiment;

FIG. 3 is a graph illustrating a relationship between a load applied to a driving source and a driving current in the collecting device according to the present exemplary embodiment;

FIG. 4 is a flowchart illustrating an operation of the collecting device according to the present exemplary embodiment;

FIG. 5 is a block diagram illustrating an example of the functional configuration of a control device used in the image forming apparatus according to the present exemplary embodiment; and

FIG. 6 is a schematic view for illustrating a relationship between a collecting path, transport augers, and the driving source of the collecting device according to the present exemplary embodiment.

### DETAILED DESCRIPTION

An exemplary embodiment of the present disclosure will be described below with reference to the drawings.

### <Image Forming Apparatus 10>

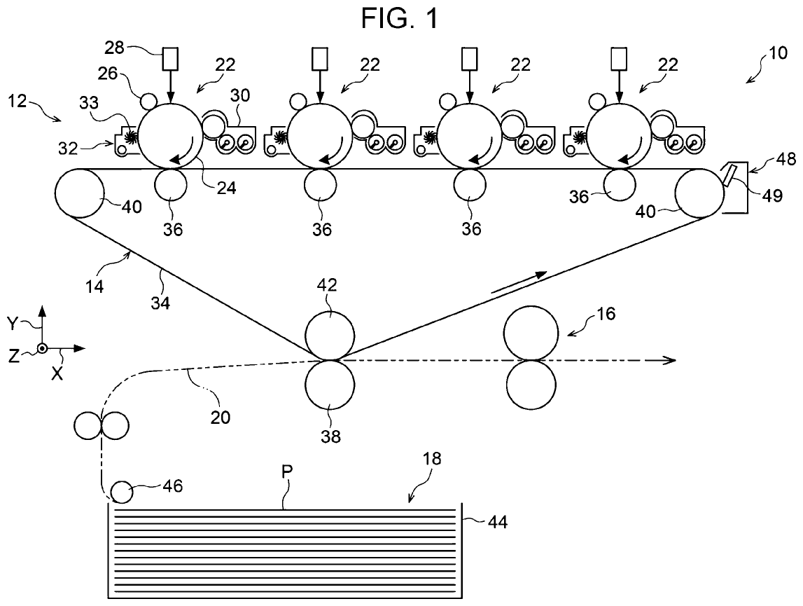

The configuration of an image forming apparatus 10 according to the present exemplary embodiment will now be described. FIG. 1 is a schematic diagram illustrating the configuration of the image forming apparatus 10 according to the present exemplary embodiment.

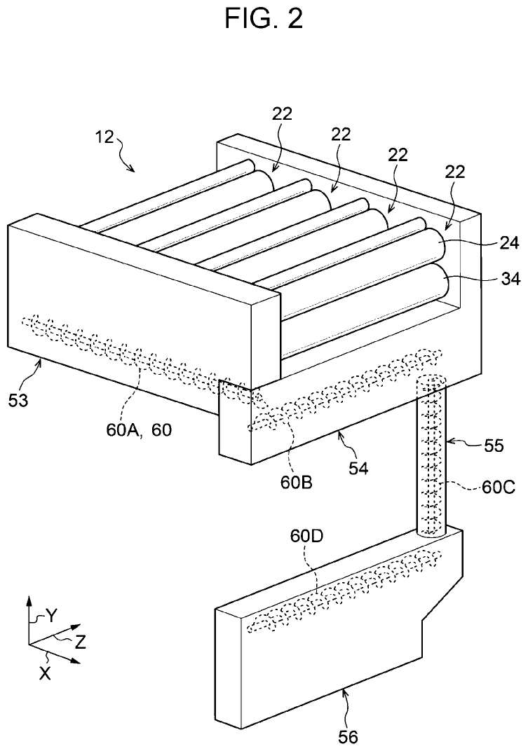

The image forming apparatus 10 includes an image forming section 12, a transfer device 14, a fixing device 16, a sheet feeding device 18, a transport path 20, a cleaning device 48, and a collecting device 50 (see FIG. 2).

For convenience of description, in the present specification and the drawings, the transverse direction and the height direction of the image forming apparatus 10 in FIG. 1 are respectively defined as the X-axis direction and the Y-axis direction, and a direction perpendicular to the X-axis direction and the Y-axis direction is defined as the Z-axis direction. In addition, in FIG. 1, the direction toward the right-hand side, the direction toward the upper side, and the direction toward the front side are respectively defined as the positive X-axis direction, the positive Y-axis direction, and the positive Z-axis direction, and these directions are the same in the other drawings.

The image forming section 12 is an example of a component that has a function of forming an image onto a recording medium P such as a sheet. More specifically, the image forming section 12 employs an electrophotographic system and forms an image onto the recording medium P. As an example, the image forming section 12 includes four image forming units 22. The four image forming units 22 form toner images of different colors such as, for example, yellow, magenta, cyan, and black. Note that, in the present exemplary embodiment, each “toner” is an example of a developer in the present disclosure, and each “toner image” is an example of a developer image in the present disclosure.

The image forming units 22 each include a photoconductor drum 24. The photoconductor drum 24 is an example of an image carrier and rotates while holding, on its outer peripheral surface, the corresponding toner image that is transferred onto the recording medium P. Each of the image forming units 22 further includes a charging device 26 that charges the photoconductor drum 24, an exposure device 28 that forms a latent image onto the charged photoconductor drum 24, a developing device 30 that develops the latent image with a toner, and a cleaning device 32 that cleans the photoconductor drum 24 after a transfer process. Note that the cleaning device 32 cleans the photoconductor drum 24 by removing the toner that remains on a surface of the photoconductor drum 24. More specifically, the cleaning device 32 includes a cleaning brush 33, which is an example of a cleaning member that removes the toner from the surface of the photoconductor drum 24.

The transfer device 14 is an example of a device having a function of transferring the toner images that have been transferred thereto from the image forming units 22 in a first transfer process onto the recording medium P in a second transfer process. The transfer device 14 includes an intermediate transfer belt 34. The toner images are transferred, in the first transfer process, from the photoconductor drums 24 onto the intermediate transfer belt 34 by first transfer members 36. The toner images transferred to the intermediate transfer belt 34 in the first transfer process are transferred onto the recording medium P by a second transfer member 38 in the second transfer process.

The intermediate transfer belt 34 is rotatably supported by a plurality of support members 40. In addition, a backup member 42 is disposed so as to face the second transfer member 38.

The fixing device 16 is an example of a device having a function of fixing the transferred toner images onto the recording medium P. More specifically, the fixing device 16 fixes the toner images that have been transferred to the recording medium P onto the recording medium P by using heat and pressure.

The sheet feeding device 18 is an example of a device having a function of feeding the recording medium P. More specifically, the sheet feeding device 18 sends out the recording medium P toward the transport path 20. The sheet feeding device 18 includes an accommodating unit 44 in which the recording medium P is accommodated and a sending member 46 that sends out the recording medium P accommodated in the accommodating unit 44 toward the transport path 20.

The transport path 20 is an example of a path along which the recording medium P is transported. More specifically, the recording medium P sent out from the sheet feeding device 18 is transported along the transport path 20 to a position between the second transfer member 38 and the backup member 42. Then, the recording medium P to which the toner images have been transferred is transported along the transport path 20 to the fixing device 16. The recording medium P to which the toner images have been fixed is further transported along the transport path 20 to an ejection unit (not illustrated).

The cleaning device 48 is an example of a device having a function of cleaning the intermediate transfer belt 34. More specifically, the cleaning device 48 cleans the intermediate transfer belt 34 by removing the toners remaining on a surface of the intermediate transfer belt 34. The cleaning device 48 includes a cleaning blade 49, which is an example of a cleaning member.

The collecting device 50 is an example of a device having a function of collecting used toners (hereinafter suitably referred to as “waste toner”). Specifically, the collecting device 50 collects the waste toner used in the image forming section 12. More specifically, the collecting device 50 collects the waste toner removed from the photoconductor drums 24 by the cleaning devices 32, the waste toner removed from the intermediate transfer belt 34 by the cleaning device 48, and the like. Details of the collecting device 50 will be described later.

In the image forming apparatus 10 having the above-described configuration, the toner images formed on the outer peripheral surfaces of the photoconductor drums 24 are transferred onto the intermediate transfer belt 34 in the first transfer process, the toner images transferred to the intermediate transfer belt 34 in the first transfer process are transferred onto the recording medium P in the second transfer process, and the toner images transferred to the recording medium P in the second transfer process are fixed onto the recording medium P by the fixing device 16. In this manner, the image forming apparatus 10 forms an image onto the recording medium P.

### <Collecting Device 50>

The configuration of the collecting device 50 will now be described in detail.

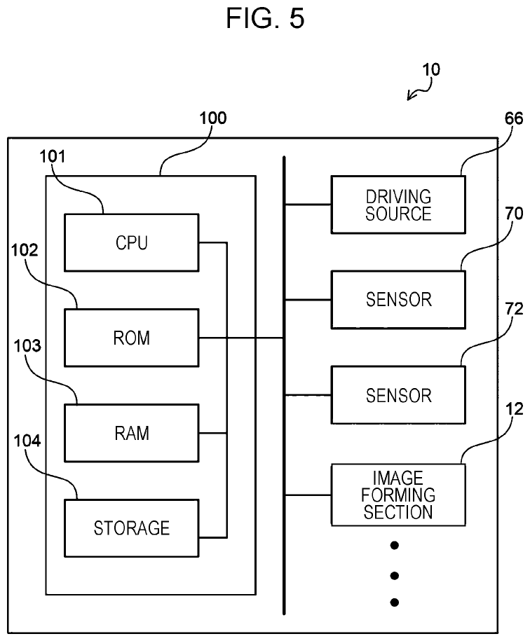

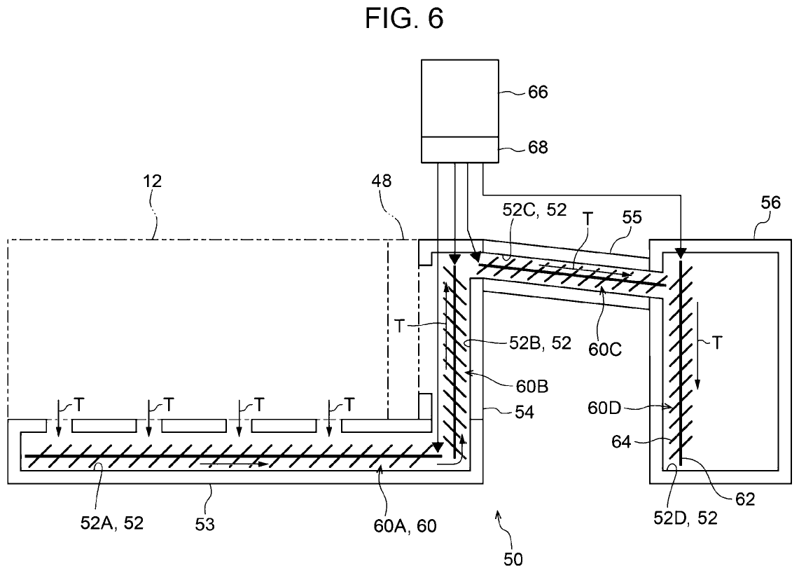

As mentioned above, the collecting device 50 is an example of a device having a function of collecting used toners (hereinafter suitably referred to as “waste toner”), and as illustrated in FIG. 2 and FIG. 6, the collecting device 50 includes a collecting path 52, transport augers 60, a driving source 66, a sensor 70 (see FIG. 5), and a control device 100. Note that the driving source 66 of the present exemplary embodiment is an example of a driving unit of the present disclosure. The sensor 70 of the present exemplary embodiment is an example of a detecting unit of the present disclosure. The control device 100 of the present exemplary embodiment is an example of a control unit of the present disclosure.

### (Collecting Path 52)

As illustrated in FIG. 2 and FIG. 6, the collecting path 52 is an example of a path for collecting the waste toner. More specifically, the collecting path 52 includes a first collecting path 52A, a second collecting path 52B, a third collecting path 52C, and a fourth collecting path 52D that are arranged in this order from the upstream side to the downstream side in a transport direction of the waste toner.

The first collecting path 52A is a path for collecting the waste toner collected by the cleaning devices 32 of the image forming units 22. The first collecting path 52A is formed in a transport container 53 that is positioned at the front side of the image forming section 12. The transport container 53 is detachably mounted on an apparatus body (not illustrated) of the image forming apparatus 10.

The second collecting path 52B is a path for collecting the waste toner collected by the cleaning device 48, which is configured to remove the toners from the intermediate transfer belt 34. The second collecting path 52B is formed in a first collecting-path member 54 that is disposed below the cleaning device 48. The first collecting-path member 54 is detachably mounted on the apparatus body.

The third collecting path 52C is a path for collecting the waste toner collected in the first collecting path 52A and the second collecting path 52B and sending the waste toner to a collecting container 56 that is disposed at a lower portion of the image forming apparatus 10. The third collecting path 52C is positioned at the rear side of the image forming section 12 and formed in a second collecting-path member 55 that connects the first collecting-path member 54 and the collecting container 56 to each other. The second collecting-path member 55 is detachably mounted on the apparatus body.

The fourth collecting path 52D is formed in the collecting container 56. The waste toner collected in each path is collected into the collecting container 56 through the fourth collecting path 52D. The collecting container 56 is provided with a sensor 72. The sensor 72 detects the amount of the waste toner collected in the collecting container 56 and transmits the detected amount to the control device 100. When the amount of the waste toner collected in the collecting container 56 exceeds a predetermined value, the control device 100 issues a notification to replace the collecting container 56. The collecting container 56 is detachably mounted on the apparatus body.

Here, the transport container 53, the first collecting-path member 54, the second collecting-path member 55, and the collecting container 56 of the present exemplary embodiment are each an example of a collecting-path component included in a collecting path of the present disclosure.

### (Transport Augers 60)

The transport augers 60 are disposed in the collecting path 52 and are each an example of a transport member having a function of transporting the waste toner by rotating. The transport augers 60 are each disposed in a corresponding one of the first collecting path 52A, the second collecting path 52B, the third collecting path 52C, and the fourth collecting path 52D. Note that the transport auger 60 disposed in the first collecting path 52A, the transport auger 60 disposed in the second collecting path 52B, the transport auger 60 disposed in the third collecting path 52C, and the transport auger 60 disposed in the fourth collecting path 52D will hereinafter be referred to as a first transport auger 60A, a second transport auger 60B, a third transport auger 60C, and a fourth transport auger 60D, respectively.

Note that each of the transport augers 60 includes a shaft 62 and a blade 64 that is formed on the shaft 62 in such a manner as to be wound around the shaft 62 and that transports the waste toner while stirring the waste toner as a result of rotation of the shaft 62.

### (Driving Source 66)

The driving source 66 has a function of driving, by receiving electric power, the transport augers 60 so that the transport augers 60 rotate. More specifically, the driving source 66 is an electric motor that rotates as a result of power being supplied thereto and causes the transport augers 60 to rotate. Note that, in the present exemplary embodiment, a stepping motor is used as the electric motor serving as the driving source 66.

In addition, in the present exemplary embodiment, each of the plurality of transport augers 60 rotates by receiving a driving force from the single driving source 66. More specifically, the driving force is transmitted from the driving source 66 to the first transport auger 60A, the second transport auger 60B, the third transport auger 60C, and the fourth transport auger 60D via a transmission mechanism 68 that includes a plurality of gears, pulleys, and the like.

### (Sensor 70)

The sensor 70 has a function of detecting a load applied to the driving source 66 due to transportation of the waste toner. More specifically, the sensor 70 is a current sensor that detects the magnitude of a driving current of the driving source 66. Here, the driving current increases as the load applied to the transport augers 60 increases, and the driving current decreases as the load decreases. The driving current detected by the current sensor serving as the sensor 70 is transmitted to the control device 100.

### (Control Device 100)

As illustrated in FIG. 5, the control device 100 includes a central processing unit (CPU: processor) 101, a read-only memory (ROM) 102, a random-access memory (RAM) 103, and a storage 104.

The CPU 101 is a central processing unit that executes various programs and controls each unit. In other words, the CPU 101 reads a program from the ROM 102 or the storage 104 and executes the program by using the RAM 103 as a work area. The CPU 101 performs control of the above-mentioned components and various arithmetic processing in accordance with the programs recorded in the ROM 102 or the storage 104.

The ROM 102 stores various programs and various data items. The RAM 103 serves as a work area and temporarily stores a program or data. The storage 104 includes a hard disk drive (HDD) or a solid-state drive (SSD) and stores various programs including an operating system and various data items.

The control device 100 controls the driving source 66 on the basis of the load that is applied to the driving source 66 and that is detected by the sensor 70. More specifically, the control device 100 controls, on the basis of the driving current detected by the sensor 70, the power that is supplied to the driving source 66.

When the detected load exceeds a threshold, the control device 100 may extend the rotation time of the transport augers 60. More specifically, when the driving current detected by the sensor 70 exceeds a threshold, the control device 100 may extend the rotation time of the transport augers 60. In other words, the control device 100 may extend the period of time during which power is supplied to the transport augers 60.

In addition, the threshold of the load that is detected by the sensor 70 may be set in stages. In the case where the threshold is set in, for example, two stages which are a first threshold and a second threshold greater than the first threshold, the control device 100 may change, in accordance with the threshold that the detected load exceeds, the length of time to which the rotation time of the transport augers 60 is extended. In the case where the detected load exceeds the second threshold, the rotation time of the transport augers 60 may be extended to be longer than that in the case where the detected load exceeds the first threshold and is less than the second threshold.

In addition, the control device 100 may increase the number of rotations of the transport augers 60 when the detected load exceeds the threshold. More specifically, the control device 100 may increase the number of rotations of the transport augers 60 when the driving current detected by the sensor 70 exceeds the threshold. Note that the “number of rotations” of the transport augers 60 refers to the number of rotations per unit time.

In the case where the threshold is set in, for example, two stages which are the first threshold and the second threshold greater than the first threshold, the control device 100 may change, in accordance with the threshold that the detected load exceeds, the amount by which the control device 100 increases the number of rotations of the transport augers 60. For example, when the detected load exceeds the second threshold, the number of rotations of the transport augers 60 may be increased to be larger than that when the detected load exceeds the first threshold and is less than the second threshold.

When the detected load exceeds the threshold, the control device 100 may cause the transport augers 60 to alternately and repeatedly perform forward and reverse rotations after the collecting device 50 has completed an operation of collecting the waste toner. More specifically, after the operation of collecting the waste toner is completed, the control device 100 may adjust the power supplied to the driving source 66 so as to cause the transport augers 60 to perform the forward and reverse rotations alternately.

In the case where the threshold is set in, for example, two stages which are the first threshold and the second threshold greater than the first threshold, the control device 100 may change, in accordance with the threshold that the detected load exceeds, the length of time to which the period of time during which the transport augers 60 repeatedly perform the forward and reverse rotations is extended. In other words, the length of time to which the period of time during which the transport augers 60 repeatedly perform the forward and reverse rotations is extended may be changed by changing the number of the forward and reverse rotations repeatedly performed by the transport augers 60. For example, when the detected load exceeds the second threshold, the period of time during which the transport augers 60 repeatedly perform the forward and reverse rotations may be further extended to be longer than that when the detected load exceeds the first threshold and is less than the second threshold by increasing the number of the forward and reverse rotations repeatedly performed by the transport augers 60.

In addition, in the case where the threshold is set in, for example, two stages which are the first threshold and the second threshold greater than the first threshold, when the detected load exceeds the first threshold, the control device 100 may perform at least one of control for extending the rotation time of the transport augers 60, control for increasing the number of rotations of the transport augers 60, and control for causing the transport augers 60 to repeatedly perform the forward and reverse rotations after the operation of collecting the waste toner is completed. When the detected load exceeds the second threshold, the control device 100 may perform control for issuing a notification to replace at least one of the collecting-path components of the collecting path 52 to the outside. Note that the collecting-path components of the collecting path 52 include the transport container 53, the first collecting-path member 54, and the second collecting-path member 55, which have been mentioned above. The notification to replace at least one of the collecting-path components may be issued to, for example, a network, a user terminal, or a display of the image forming apparatus 10.

Furthermore, in the case where the threshold is set in, for example, two stages which are the first threshold and the second threshold greater than the first threshold, when the detected load exceeds the first threshold, the control device 100 may perform at least one of control for extending the rotation time of the transport augers 60, control for increasing the number of rotations of the transport augers 60, and control for causing the transport augers 60 to repeatedly perform the forward and reverse rotations after the operation of collecting the waste toner is completed. When the detected load exceeds the second threshold, the control device 100 may perform control for issuing a notification to replace at least one of the image forming units 22 to the outside. Note that, if the photoconductor drums 24 are replaceable by being detached from their respective image forming units 22, only at least one of the photoconductor drums 24 may be replaced. The notification to replace at least one of the image forming units 22 (at least one of the photoconductor drums 24) may be issued to, for example, a network, a user terminal, or a display of the image forming apparatus 10.

An example of a collecting operation that the transport augers 60 are caused to perform by the control device 100 of the present exemplary embodiment will now be described. Note that the collecting operation which will be described below is an example, and the present disclosure is not limited to the collecting operation.

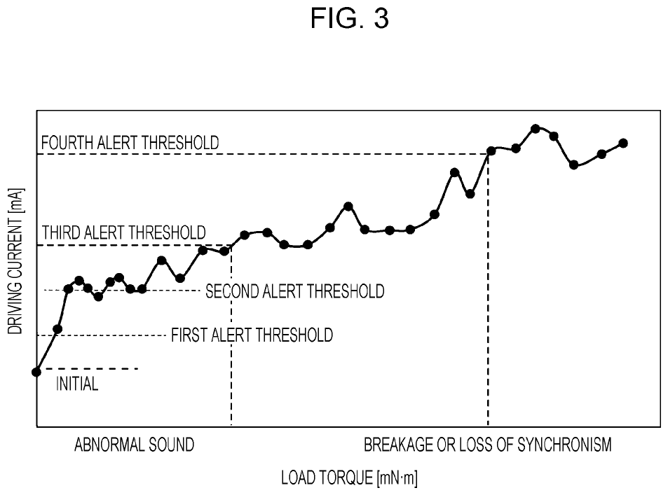

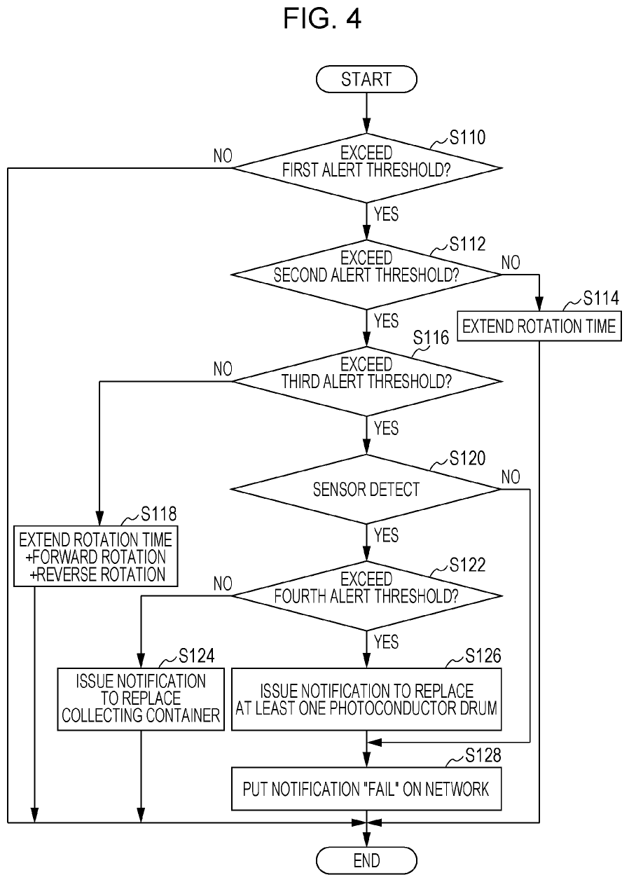

In the present exemplary embodiment, as illustrated in FIG. 3 and FIG. 4, the threshold of the driving current is set in four stages.

First, the image forming apparatus 10 forms an image, that is, executes a print job, so that the toners are used in the image forming units 22. The toners (waste toner T) used in the image forming units 22 are sent from the cleaning devices 32 to the first collecting path 52A of the transport container 53 as illustrated in FIG. 6. The waste toner collected in the first collecting path 52A is sent to the second collecting path 52B of the first collecting-path member 54 by rotation of the first transport auger 60A. The waste toner removed from the intermediate transfer belt 34 by the cleaning device 48 is sent to the second collecting path 52B. As a result, the waste toner removed from the photoconductor drums 24 by the cleaning devices 32 and the waste toner removed from the intermediate transfer belt 34 by the cleaning device 48 are mixed together in the second collecting path 52B. The mixed waste toner is sent to the third collecting path 52C of the second collecting-path member 55 by rotation of the second transport auger 60B. The waste toner sent to the third collecting path 52C is further sent to the fourth collecting path 52D of the collecting container 56 by rotation of the third transport auger 60C. The waste toner sent to the fourth collecting path 52D is collected in the collecting container 56.

Here, when the waste toner is transported (collected) by rotations of the transport augers 60, a load is applied to the driving source 66 via the transport augers 60. When the load applied to the driving source 66 increases, the driving current detected by the sensor 70 increases in proportion thereto. Then, when the load applied to the driving source 66 exceeds the threshold, the control device 100 causes the transport augers 60 to perform the collecting operation in accordance with the detected load. More specifically, as illustrated in FIG. 3 and FIG. 4, the control device 100 first determines, in step S110, whether the driving current detected by the sensor 70 exceeds a first alert threshold. If the detected driving current is equal to or less than the first alert threshold, the control device 100 causes the transport augers 60 to perform the collecting operation in a usual manner. In contrast, if the detected driving current exceeds the first alert threshold, the process proceeds to step S112.

In step S112, it is determined whether the detected driving current exceeds a second alert threshold. Here, if the detected driving current is equal to or less than the second alert threshold, the process proceeds to step S114, and the rotation time of the transport augers 60 is extended. As a result, transportation of the waste toner in the collecting path 52 is facilitated. In contrast, if the detected driving current exceeds the second alert threshold, the process proceeds to step S116.

In step S116, it is determined whether the detected driving current exceeds a third alert threshold. Here, if the detected driving current is equal to or less than the third alert threshold, the process proceeds to step S118, and the rotation time of the transport augers 60 is extended. After that, the transport augers 60 are caused to repeatedly perform the forward and reverse rotations. As a result, transportation of the waste toner in the collecting path 52 is facilitated. In addition, the waste toner in the collecting path 52 is smoothened in the transport direction. In contrast, if the detected driving current exceeds the third alert threshold, the process proceeds to step S120.

In step S120, it is determined whether the sensor 72 has detected that the amount of the waste toner collected in the collecting container 56 has exceeded a predetermined amount. The sensor 72 is configured to output a signal when it detects that the amount of the waste toner collected in the collecting container 56 has exceeded the predetermined amount. Here, if the sensor 72 has not detected the amount of waste toner exceeding the predetermined amount, the detected driving current exceeds the third alert threshold before the predetermined amount of the waste toner is collected in the collecting container 56. Thus, the process proceeds to step S128, and a notification “FAIL” is put on the network.

In step S122, it is determined whether the detected driving current exceeds a fourth alert threshold. Here, if the detected driving current is equal to or less than the fourth alert threshold, the process proceeds to step S124, and a notification to replace the collecting container 56 is issued. In contrast, if the detected driving current exceeds the fourth alert threshold, the process proceeds to step S126.

In step S126, a notification to replace at least one of the photoconductor drums 24 is issued. Note that, if the corresponding image forming unit 22 needs to be replaced in order to replace the photoconductor drum 24, the photoconductor drum 24 is replaced together with the image forming unit 22. After the notification to replace at least one of the photoconductor drums 24 has been issued, the process proceeds to step S128, and the notification “FAIL” is put on the network. Putting the notification “FAIL” on the network makes it easy for a user or the like to place an order for repair or replacement work.

Note that, if the detected driving current exceeds the fourth alert threshold even after at least one of the photoconductor drums 24 has been replaced, there is a possibility that a problem such as clogging of at least one of the first collecting path 52A, the second collecting path 52B, the third collecting path 52C, and the fourth collecting path 52D with the waste toner has occurred. Thus, if the detected driving current exceeds the fourth alert threshold even after the notification to replace at least one of the photoconductor drums 24 has been issued in step S126, a notification to replace at least one of the collecting-path components may be issued.

### Operation According to Present Exemplary Embodiment

An operation according to the present exemplary embodiment will now be described.

In the present exemplary embodiment, the control device 100 controls the driving source 66 on the basis of the load that is applied to the transport augers 60 and that is detected by the sensor 70. More specifically, the control device 100 controls the driving source 66 so as to control the rotation time of the transport augers 60, the number of rotations of the transport augers 60, and the rotational operations (forward and reverse rotations) of the transport augers 60.

The collecting container 56, which is one of the collecting-path components, is a container that collects the waste toner and is a replaceable component that is to be replaced after a certain amount of the waste toner has been collected therein.

### (Modification)

In the above-described exemplary embodiment, although the third transport auger 60C is disposed in the third collecting path 52C as illustrated in FIG. 2, the present disclosure is not limited to this configuration. A configuration in which the third transport auger 60C is not disposed in the third collecting path 52C may be employed. Even in this case, since the third collecting path 52C extends in the vertical direction, the waste toner sent to the third collecting path 52C moves to the fourth collecting path 52D under its own weight.

The present disclosure is not limited to the above-described exemplary embodiment, and various modifications, changes, and improvements may be made within the gist of the present disclosure. For example, the above-described modification may be suitably combined with other modifications.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A collecting device comprising:
a collecting path for a developer;
at least one transport member that is disposed in the collecting path and that transports the developer by rotating;
a driving unit that drives, by receiving electric power, the transport member in such a manner that the transport member rotates;
a detecting unit that detects a load applied to the driving unit due to transportation of the developer; and
a control unit that controls the driving unit based on the load detected by the detecting unit.
   (((2)))

The collecting device according to (((1))),
wherein the control unit extends a rotation time of the transport member when the detected load exceeds a threshold.
   (((3)))

The collecting device according to (((2))),
wherein the threshold is set in stages, and
wherein the control unit changes, in accordance with the threshold that the detected load exceeds, a length of time to which the rotation time of the transport member is extended.
   (((4)))

The collecting device according to any one of (((1))) to (((3))),
wherein the control unit increases the number of rotations of the transport member when the detected load exceeds a threshold.
   (((5)))

The collecting device according to (((4))),
wherein the threshold is set in stages, and
wherein the control unit changes, in accordance with the threshold that the detected load exceeds, an amount by which the control unit increases the number of rotations of the transport member.
   (((6)))

The collecting device according to any one of (((1))) to (((5))),
wherein, when the detected load exceeds a threshold, the control unit causes the transport member to alternately and repeatedly perform forward and reverse rotations after an operation of collecting the developer is completed.
   (((7)))

The collecting device according to (((2))),
wherein the threshold is set in stages, and
wherein the control unit changes, in accordance with the threshold that the detected load exceeds, a length of time to which a period of time during which the transport member repeatedly performs forward and reverse rotations is extended.
   (((8)))

The collecting device according to any one of (((1))) to (((7))), further comprising:
a collecting-path component that is included in the collecting path and that is detachable from the collecting path,
wherein, when the detected load exceeds a first threshold, the control unit performs at least one of control for extending a rotation time of the transport member, control for increasing the number of rotations of the transport member, and control for causing the transport member to repeatedly perform forward and reverse rotations after an operation of collecting the developer is completed, and
wherein, when the detected load exceeds a second threshold that is greater than the first threshold, the control unit performs control for issuing a notification to replace the collecting-path component to outside.
   (((9)))

The collecting device according to (((8))),
wherein the collecting-path component forming a downstream-side portion of the collecting path in a transport direction of the developer is a collecting container that collects the developer.
   (((10)))

The collecting device according to any one of (((1))) to (((7))),
wherein a use device that uses the developer is disposed on the collecting path,
wherein the developer used by the use device is collected in the collecting path,
wherein, when the detected load exceeds a first threshold, the control unit performs at least one of control for extending a rotation time of the transport member, control for increasing the number of rotations of the transport member, and control for causing the transport member to repeatedly perform forward and reverse rotations after an operation of collecting the developer is completed, and
wherein, when the detected load exceeds a second threshold that is greater than the first threshold, the control unit performs control for issuing a notification to replace the use device to outside.
   (((11)))

The collecting device according to any one of (((1))) to (((10))),
wherein the at least one transport member includes a plurality of transport members,
wherein the plurality of transport members are arranged in the collecting path, and
wherein each of the plurality of transport members rotates by receiving a driving force from a single driving unit that is the driving unit.
   (((12)))

An image forming apparatus comprising:
an image forming section that forms an image onto a recording medium by using a developer; and
the collecting device according to any one of (((1))) to (((11))) that collects the developer used by the image forming section.

What is claimed is:

1. A collecting device comprising:
a collecting path for a developer;
at least one transport member that is disposed in the collecting path and that transports the developer by rotating;
a driving unit that drives, by receiving electric power, the transport member in such a manner that the transport member rotates;
a detecting unit that detects a load applied to the driving unit due to transportation of the developer; and
a control unit that controls the driving unit based on the load detected by the detecting unit.

2. The collecting device according to claim 1,
wherein the control unit extends a rotation time of the transport member when the detected load exceeds a threshold.

3. The collecting device according to claim 2,
wherein the threshold is set in stages, and
wherein the control unit changes, in accordance with the threshold that the detected load exceeds, a length of time to which the rotation time of the transport member is extended.

4. The collecting device according to claim 1,
wherein the control unit increases the number of rotations of the transport member when the detected load exceeds a threshold.

5. The collecting device according to claim 4,
wherein the threshold is set in stages, and
wherein the control unit changes, in accordance with the threshold that the detected load exceeds, an amount by which the control unit increases the number of rotations of the transport member.

6. The collecting device according to claim 1,
wherein, when the detected load exceeds a threshold, the control unit causes the transport member to alternately and repeatedly perform forward and reverse rotations after an operation of collecting the developer is completed.

7. The collecting device according to claim 2,
wherein the threshold is set in stages, and
wherein the control unit changes, in accordance with the threshold that the detected load exceeds, a length of time to which a period of time during which the transport member repeatedly performs forward and reverse rotations is extended.

8. The collecting device according to claim 1, further comprising:
a collecting-path component that is included in the collecting path and that is detachable from the collecting path,
wherein, when the detected load exceeds a first threshold, the control unit performs at least one of control for extending a rotation time of the transport member, control for increasing the number of rotations of the transport member, and control for causing the transport member to repeatedly perform forward and reverse rotations after an operation of collecting the developer is completed, and
wherein, when the detected load exceeds a second threshold that is greater than the first threshold, the control unit performs control for issuing a notification to replace the collecting-path component to outside.

9. The collecting device according to claim 8,
wherein the collecting-path component forming a downstream-side portion of the collecting path in a transport direction of the developer is a collecting container that collects the developer.

10. The collecting device according to claim 1,
wherein a use device that uses the developer is disposed on the collecting path,
wherein the developer used by the use device is collected in the collecting path,
wherein, when the detected load exceeds a first threshold, the control unit performs at least one of control for extending a rotation time of the transport member, control for increasing the number of rotations of the transport member, and control for causing the transport member to repeatedly perform forward and reverse rotations after an operation of collecting the developer is completed, and
wherein, when the detected load exceeds a second threshold that is greater than the first threshold, the control unit performs control for issuing a notification to replace the use device to outside.

11. The collecting device according to claim 1,
wherein the at least one transport member includes a plurality of transport members,
wherein the plurality of transport members are arranged in the collecting path, and
wherein each of the plurality of transport members rotates by receiving a driving force from a single driving unit that is the driving unit.

12. An image forming apparatus comprising:
an image forming section that forms an image onto a recording medium by using a developer; and
the collecting device according to claim 1 that collects the developer used by the image forming section.

13. An image forming apparatus comprising:
an image forming section that forms an image onto a recording medium by using a developer; and
the collecting device according to claim 2 that collects the developer used by the image forming section.

14. An image forming apparatus comprising:
an image forming section that forms an image onto a recording medium by using a developer; and
the collecting device according to claim 3 that collects the developer used by the image forming section.

15. An image forming apparatus comprising:
an image forming section that forms an image onto a recording medium by using a developer; and
the collecting device according to claim 4 that collects the developer used by the image forming section.

16. An image forming apparatus comprising:
an image forming section that forms an image onto a recording medium by using a developer; and
the collecting device according to claim 5 that collects the developer used by the image forming section.

17. An image forming apparatus comprising:
an image forming section that forms an image onto a recording medium by using a developer; and
the collecting device according to claim 6 that collects the developer used by the image forming section.

18. An image forming apparatus comprising:
an image forming section that forms an image onto a recording medium by using a developer; and
the collecting device according to claim 7 that collects the developer used by the image forming section.

19. An image forming apparatus comprising:
an image forming section that forms an image onto a recording medium by using a developer; and
the collecting device according to claim 8 that collects the developer used by the image forming section.

20. An image forming apparatus comprising:
an image forming section that forms an image onto a recording medium by using a developer; and
the collecting device according to claim 9 that collects the developer used by the image forming section.
